(19) United States
(12) Patent Application Publication
(10) Pub. No.: US 2026/0239364 A1
(43) Pub. Date: Aug. 13, 2026

(54) TRANSMISSION START AND STOP TIME INDICATION FOR SEAMLESS ROAMING

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/462,860

(22) Filed: Jan. 28, 2026

Related U.S. Application Data
(60) Provisional application No. 63/756,384, filed on Feb. 10, 2025.
(60) Provisional application No. 63/767,852, filed on Mar. 6, 2025.
(60) Provisional application No. 63/922,540, filed on Nov. 21, 2025.

(51) Int. Cl. H04W 72/23; H04W 52/02; H04W 76/15

(52) U.S. Cl. CPC H04W 72/23; H04W 52/0235; H04W 76/15

(57) ABSTRACT

Transmission start and stop time indication for seamless roaming in wireless local areas (WLANs). A method performed by a non-access point (AP) multi-link device (MLD) is provided. The method includes transmitting, to a current AP MLD, a first message indicating to stop transmission to the non-AP MLD for the non-AP MLD to roam from the current AP MLD to a target AP MLD; transmitting, to the target AP MLD, a second message indicating to start transmission to the non-AP MLD; and receiving, from the target AP MLD, downlink (DL) data frames after transmission of the second message.

### CROSS-REFERENCE TO RELATED APPLICATIONS AND CLAIM OF PRIORITY

This application claims priority under 35 U.S.C. § 119 (e) to U.S. Provisional Patent Application No. 63/756,384 filed on Feb. 10, 2025; U.S. Provisional Patent Application No. 63/767,852 filed on Mar. 6, 2025; and U.S. Provisional Patent Application No. 63/922,540, filed on Nov. 21, 2025. The above-identified provisional patent applications are hereby incorporated by reference in their entirety.

### TECHNICAL FIELD

This disclosure relates generally to wireless networks. More specifically, this disclosure relates to transmission start and stop time indication for seamless roaming in wireless local areas (WLANs) including next generation WLANs.

### BACKGROUND

WLAN technology allows devices to access the internet in the 2.4 GHZ, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for transmission start and stop time indication for seamless roaming in WLANs.

In one embodiment, a method performed by a non-access point (AP) multi-link device (MLD) is provided. The method includes transmitting, to a current AP MLD, a first message indicating to stop transmission to the non-AP MLD for the non-AP MLD to roam from the current AP MLD to a target AP MLD; transmitting, to the target AP MLD, a second message indicating to start transmission to the non-AP MLD; and receiving, from the target AP MLD, downlink (DL) data frames after transmission of the second message.

In another embodiment, a method performed by a target AP MLD is provided. The method includes receiving, from the non-AP MLD, a second message indicating to start transmission to the non-AP MLD and transmitting, to the non-AP MLD, DL data frames after receipt of the second message. A first message indicates to stop transmission to the non-AP MLD for the non-AP MLD to roam from a current AP MLD to the target AP MLD.

In yet another embodiment, an electronic device is provided. The electronic device includes at least one processor including processing circuitry and memory storing instructions. The instructions, when executed by the at least one processor individually or collectively, cause the electronic device to transmit, to a current AP MLD, a first message indicating to stop transmission to the non-AP MLD for the non-AP MLD to roam from the current AP MLD to a target AP MLD; transmit, to the target AP MLD, a second message indicating to start transmission to the non-AP MLD; and receive, from the target AP MLD, DL data frames after transmission of the second message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIGS. 3A-3C illustrate example procedures for start and stop message indication signaling according to embodiments of the present disclosure;

FIGS. 4A-4B illustrate example procedures for power save mode based operation signaling according to embodiments of the present disclosure;

FIG. 5 illustrates an example of a power save indication in A-control field according to embodiments of the present disclosure; and

FIG. 6 illustrates an example method performed by a non-AP MLD in a wireless communication system according to embodiments of the present disclosure.

### DETAILED DESCRIPTION

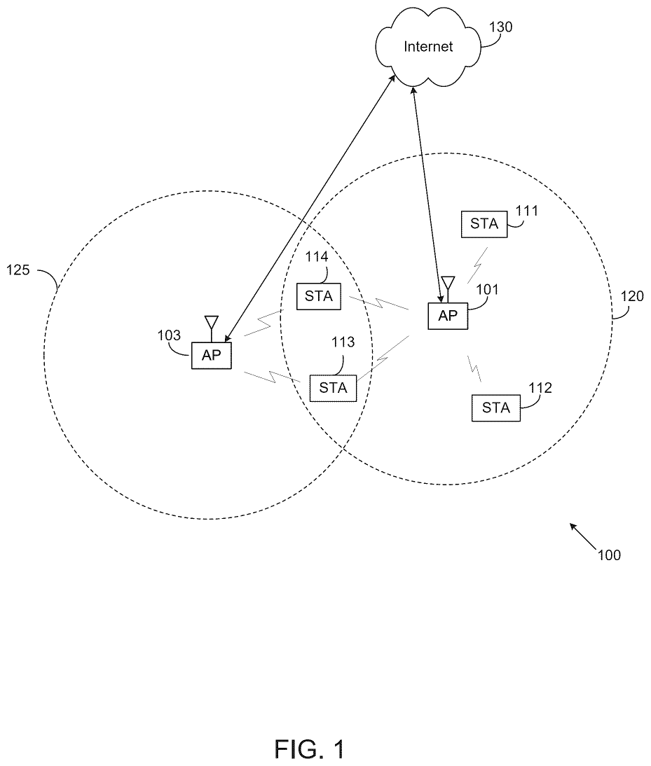

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be/D7.0, 2024; [2] IEEE Std 802.11-2020; and [3] IEEE P802.11bn/D1.0, 2025.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for transmission start and stop time indication for seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

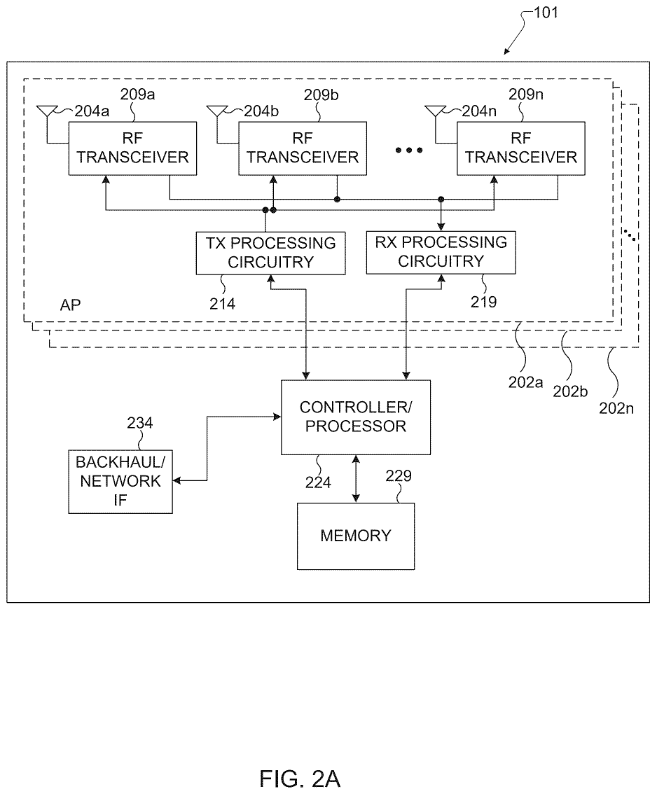

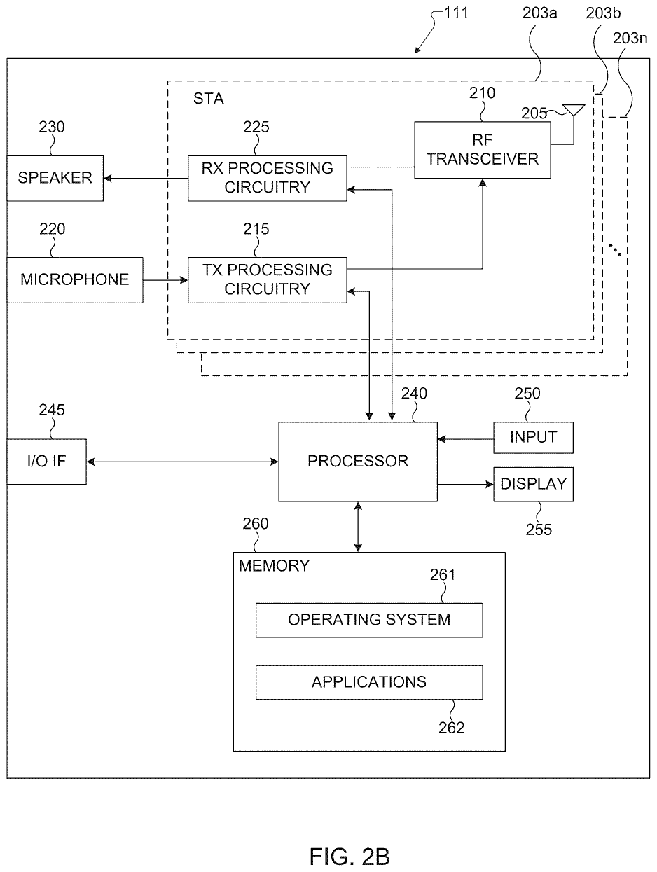

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including transmission start and stop time indication for seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for transmission start and stop time indication for seamless roaming in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate transmission start and stop time indication for seamless roaming in WLANs. In some embodiments, the processor 240 includes at least one microprocessor or microcontroller.

The processor 240 is also capable of executing other processes and programs resident in the memory 260, such as operations for transmission start and stop time indication for seamless roaming in WLANs. The processor 240 can move data into or out of the memory 260 as required by an executing process. In some embodiments, the processor 240 is configured to execute a plurality of applications 262, such as applications for transmission start and stop time indication for seamless roaming in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Seamless roaming in WLANs is a roaming procedure for a non-AP MLD (e.g., STA 111) to transition from a current AP MLD (e.g., AP 101) to a target AP MLD (e.g., AP 103) with a goal such that the time during which the connection is lost is minimal. The seamless roaming procedure can enable a non-AP MLD to remain in state 4 of association while transitioning from current AP MLD to target AP MLD.

The roaming procedure can include multiple stages. Two of the important stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from current AP MLD to target AP MLD. The current AP MLD can process the request frame and send a response frame to the non-AP MLD after the transfer of context is complete. These procedures can enable the non-AP MLD to seamlessly roam from current to target AP MLD.

Embodiments of the present disclosure recognize that the non-AP MLD, which can include one or more non-AP STAs affiliated with it, can be capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can transition between the AP MLDs. The SMD includes a SMD management entity (SMD-ME) for the SMD. The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, stream classification service (SCS), mirrored stream classification service (MSCS), emergency preparedness communication service (EPCS), etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

Following the execution procedure, the current AP MLD can continue to transmit DL data frames to the non-AP MLD for a certain period of time. This period of time can be referred to as the DL draining period and can start after the reception of the acknowledgement of the state transition (ST) execution response and terminating after a nominal duration indicated by the nominal maximum DL draining period duration field in the ST execution response.

Embodiments of the present disclosure further recognize and take into consideration that, when a non-AP MLD completes roaming execution phase, the non-AP MLD may not switch its channel and roam to target AP MLD. For instance, a non-AP MLD may have to retrieve buffered frames from its current AP MLD during the DL draining period. Further, the links at the target AP MLD can already be setup prior to the transition. Consequently, the target AP MLD may not know the time at which the non-AP MLD has switched to the target AP MLD's links. Consequently, the target AP MLD may not know the time at which the target AP MLD can start its transmission to the non-AP MLD on the downlink. Accordingly, embodiments of the present disclosure provide mechanisms and procedures by which the non-AP MLD can inform the target AP MLD about its transition to the target AP MLD's links.

Further, embodiments of the present disclosure further recognize and take into consideration that the current AP MLD may also not know if the non-AP MLD is on its links or has already transitioned to the target AP MLD. Consequently, the current AP MLD may not know when to stop transmitting frames to the non-AP MLD. Embodiments of the present disclosure recognize that knowledge of the non-AP MLD's transition to the target AP MLD's links can be useful to the current AP MLD.

Accordingly, embodiments of the present disclosure provide a number of solutions for handling transmission start and stop framework for seamless roaming. Various embodiments include, but are not limited to, a start and stop message, a power save indication based start and stop indication, dynamic unavailability indication, null frame based start indication, uplink frame based start indication, a link delete/timeout based indication, and any combinations thereof.

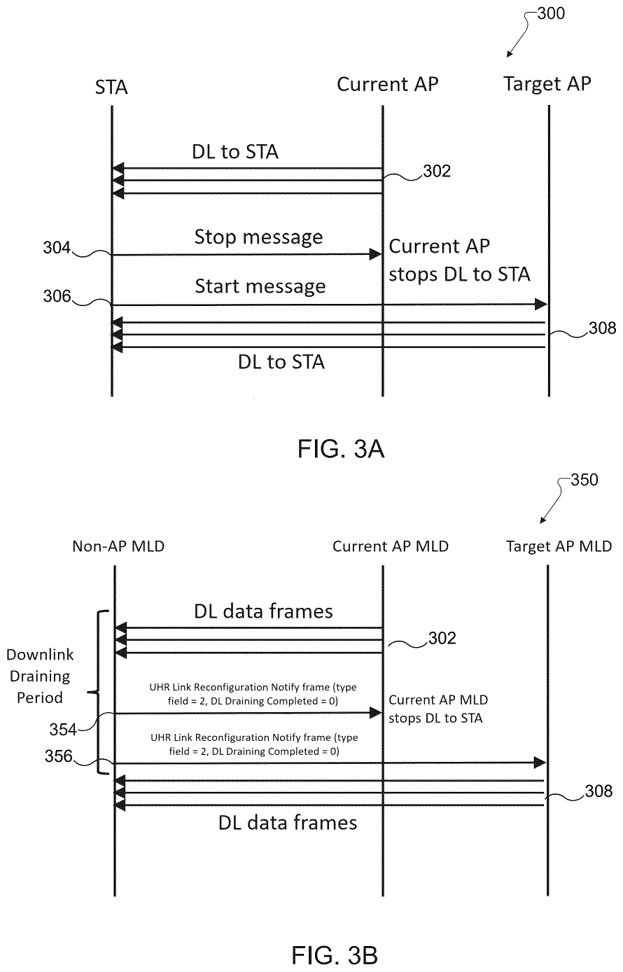

FIGS. 3A-3C illustrate example procedures 300, 350, and 370 for start and stop message indication signaling according to embodiments of the present disclosure. For example, the procedures 300, 350, and 370 of FIG. 3A-3C can be performed between any of the STAs 111-114 of FIG. 1, such as the non-AP MLD 111 of FIG. 2B and any of the APs 101-103 of FIG. 1, such as AP MLD 101 of FIG. 2A. The procedures 300, 350, and 370 are for illustration only and other embodiments can be used without departing from the scope of the present disclosure.

As illustrated in FIG. 3A, according to one embodiment, there can be a start and stop message indication. For example, the non-AP MLD (e.g., non-AP MLD 111) receives DL data from its current AP MLD (e.g., AP MLD 101) over one or more links (e.g., 3 links as illustrated) (302). The non-AP MLD is in the process of roaming from the current AP MLD to the target AP MLD. The non-AP MLD can provide a stop message to its current AP MLD (e.g., AP MLD 101) to stop transmitting frames to it (304). When the current AP MLD receives a stop message from the non-AP MLD, the current AP MLD can stop transmitting frames to the non-AP MLD as per the stop message. For example, the non-AP MLD may be ready to start receiving frames from the target AP MLD as part of the roam procedure.

The non-AP MLD can switch channels and transmit a start message to its target AP MLD to inform the target AP MLD to start transmitting messages to it (306). When a target AP MLD receives a start message from a non-AP MLD, the target AP MLD can start to transmit frames to the non-AP MLD as per the start message over one or more links (e.g., 3 links as illustrated) (308).

The start and stop messages can include at least one or more of the information items as shown in Table 1.

TABLE 1
Information items that can be present in the start and stop messages

| Information | |
|---|---|
| item | Description |
| Start/stop | One or more information items that can provide a |
| indication | start/stop indication to the target and current AP |
| | MLD. E.g., a bit that can take a predetermined value |
| | (e.g., 1) to indicate a stop message and another |
| | predetermined value (e.g., 0) to indicate start. |
| Start time | One or more information items that can indicate a |
| indication | start time for the start or stop message. E.g., a start |
| | time indicated relative to the timing synchronization |
| | function (TSF) timer using a few bits of the timer. |
| Link | One or more information items that can indicate |
| indication | the link on which the start or stop action can occur. |
| | E.g., a link bitmap, link identifier (ID) list, etc. |

As illustrated, non-AP MLD (or in other words a STA affiliated with the non-AP MLD) can be receiving DL data frames from the current AP MLD post ST-execution phase (e.g., as illustrated in 302). This can be a DL draining period that follows the ST execution phase. To stop the DL transmissions or in other words terminate the DL draining period before the expiration of the nominal duration, the non-AP MLD can transmit a stop message to the current AP MLD (e.g., as illustrated in 402). Upon receiving the message, the current AP MLD can terminate the DL draining period and stop transmitting DL frames to the non-AP MLD. This can be an indication to the current AP MLD that the non-AP MLD intends to transition to the target AP MLD.

The non-AP MLD can then transmit a start message to the target AP MLD (e.g., as illustrated in 306). The target AP MLD can then start DL transmissions to the non-AP MLD (e.g., as illustrated in 308).

The DL draining period can end without the non-AP MLD transmitting the stop message to the current AP MLD i.e., the nominal duration can elapse. After the nominal duration elapses, the current AP MLD can stop transmitting DL frames to the non-AP MLD. In this case as well, the non-AP MLD can transmit a start message to the target AP MLD. The target AP MLD can then start DL transmissions to the non-AP MLD.

In the example procedure 350 in FIG. 3B, if the DL draining period is ongoing (i.e., if the non-AP MLD has not received a UHR Link Reconfiguration Notify frame with the Type field set to 2 and the DL Draining Completed field set to 0) and the non-AP MLD terminates the DL draining period before the expiration of its nominal duration, the non-AP MLD can transmit a UHR Link Reconfiguration Notify frame to the current AP MLD with the Type field set to 2 and the DL Draining Completed Type field set to 0 to indicate termination of the DL draining period (354). Setting the type field to 2 and the DL draining completed type field to 0 can be an example of start/stop indication described in Table 1. Transmitting the UHR link reconfiguration notify frame to the current AP MLD can be an example of transmitting a stop message to the current AP MLD shown in 304 of FIG. 3A.

Further as shown in FIG. 3B, the non-AP MLD can send a UHR Link Reconfiguration Notify frame to the target AP MLD with the Type field set to 2 and the DL Draining Completed field set to 0 to indicate termination of the DL draining period before the expiration of its nominal duration (356). Setting the type field set to 2 and the DL Draining Completed field set to 0 can be an example of start/stop indication described in Table 1. Transmitting the UHR link reconfiguration notify frame to the current AP MLD can be an example of transmitting a start message to the target AP MLD as shown in 306 of FIG. 3A.

As shown in FIG. 3C, the DL draining period can end without an early termination i.e., the nominal duration can elapse. Following this, the current AP MLD can stop transmitting DL frames to the non-AP MLD. The non-AP MLD can send a UHR Link Reconfiguration Notify frame to the target AP MLD with the Type field set to 2 and the DL Draining Completed field set to 0 to indicate termination of the DL draining period when its nominal duration expires without any early termination (376). Transmitting a UHR Link Reconfiguration Notify frame can be an example of transmitting a start message to the target AP MLD, e.g., as in 306 of FIG. 3A. Setting type field set to 2 and the DL Draining Completed field set to 0 is an example of start/stop indication from Table 1.

If the non-AP MLD had requested the current AP MLD to not transfer the next sequence number (SN) for DL individually addressed data frame for each traffic identifier (TID) in the ST preparation request, then the target AP MLD cannot transmit DL data frames to the non-AP MLD until receiving a start message from the non-AP MLD. Further, after receiving a start message from the non-AP MLD, the target AP MLD can transmit DL frames to the non-AP MLD subject to the power states of the affiliated STAs of the non-AP MLD (e.g., as discussed in greater detail below). The target AP MLD can reset the SNs to 0 for all DL TIDs before starting transmissions of DL data frames to the non-AP MLD.

If the non-AP MLD had requested the current AP MLD to transfer the next SN for DL individually addressed data frame for each TID by setting to zero the Request DL SN Not Transferred field carried in the ST preparation request, the target AP MLD can transmit DL Data frames to the non-AP MLD subject to the power states of the affiliated STAs of the non-AP MLD (e.g., as discussed in greater detail below). The target AP MLD can assign SN for the DL individually addressed data frames for each DL TID starting with the next SN values that were received during the context transfer. The target AP MLD cannot transmit DL Data frames to the non-AP MLD with SN values above Win-StartO+Buffer Size (of the current AP MLD) received during context transfer, unless the non-AP MLD has transmitted the start message. The target AP MLD cannot advance the DL buffer control for any TID unless the non-AP MLD has indicated termination of the DL draining period.

Various embodiments of the present disclosure provide for power save indication based start and stop indication. According to one embodiment, a non-AP MLD can indicate a start of a power save mode to its current AP MLD. Upon receiving the message from the non-AP MLD, the current AP MLD can stop transmitting frames to the non-AP MLD as per the start of the power save mode.

According to one embodiment, the target AP MLD can assume a default power save mode ON state for a non-AP MLD that has completed roam execution phase to the target AP MLD via another AP MLD (non-AP MLD's current AP MLD) in the same UHR seamless roaming domain. To elaborate, the non-AP MLD can have a default power save mode ON for the links added by the non-AP MLD during the preparation phase or during the execution phase.

According to one embodiment, a non-AP MLD can indicate the stop of a power save mode to the target AP MLD after transitioning to the target AP MLD's links. Upon receiving the message from the non-AP MLD, the target AP MLD can start to transmit frames to the non-AP MLD as per the stop of the power save mode.

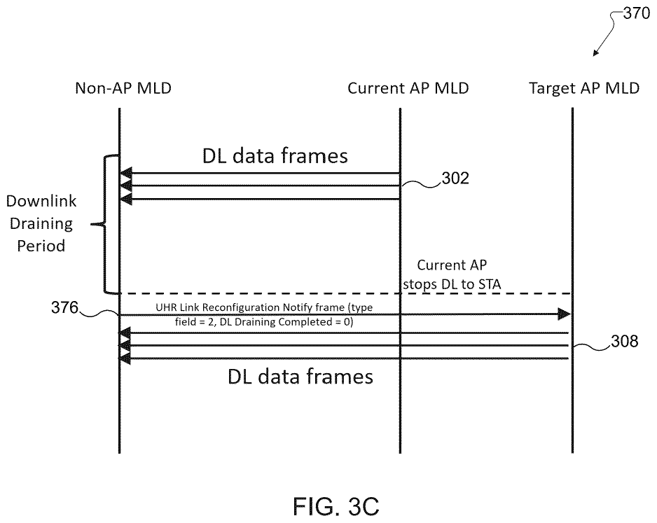

FIGS. 4A-4B illustrate example procedures 400 and 450 for power save mode based operation signaling according to embodiments of the present disclosure. For example, the procedures 400 and 450 of FIG. 4A-4B can be performed between any of the STAs 111-114 of FIG. 1, such as the non-AP MLD 111 of FIG. 2B and any of the APs 101-103 of FIG. 1, such as AP MLD 101 of FIG. 2A. The procedures 400 and 450 are for illustration only and other embodiments can be used without departing from the scope of the present disclosure.

As illustrated in FIG. 4A, the STA (e.g., one of the STAs of the non-AP MLD) can transmit a preparation request frame to the current AP (e.g., the one of the APs of the AP MLD) (402). Based on the reception of the preparation request frame, the current AP and target AP communicate (404) to prepare for the roaming procedure, and the links can be added at the target AP MLD. The default state of these links can be power save. In other words, when a non-AP MLD receives an ST preparation response from the current AP MLD indicating that the SMD BSS transition preparation was successfully completed at the target AP MLD (406), the non-AP MLD can be in power save mode for all the setup links with the target AP MLD. After completion of the roam/execution phase (408), the STA (affiliated with the non-AP MLD) can transmit an uplink frame to the target AP with the power management (PM) bit set to 0 (410). Upon receiving the frame, the target AP can then start to transmit frames to the STA (412).

In another example shown in FIG. 4B, the STA (e.g., one of the STAs of the non-AP MLD) can complete the roam execution phase with the current AP (e.g., the one of the APs of the AP MLD), for example, by transmitting a roam execution request (452) and receiving a roam execution response (456). Upon completion of the roam execution phase, the links added can be in PS mode (454). The STA can then transmit an uplink frame to the target AP with PM bit set to 0 and the links can come out of PS mode/state (458). When a link comes out of PS (power save), the target AP/target AP MLD can start to transmit frames to the non-AP MLD on that link (460). For example, the transmission on the link in 458 is the start indication for that link. In this manner, the STA and AP can take the links out of power save mode individually and implicitly by the start indication being specific to the link on which the start indication was transmitted/received. In other examples, the start indication can apply to all links between the non-AP MLD and the target AP MLD regardless of the link on which the start indication was transmitted/received.

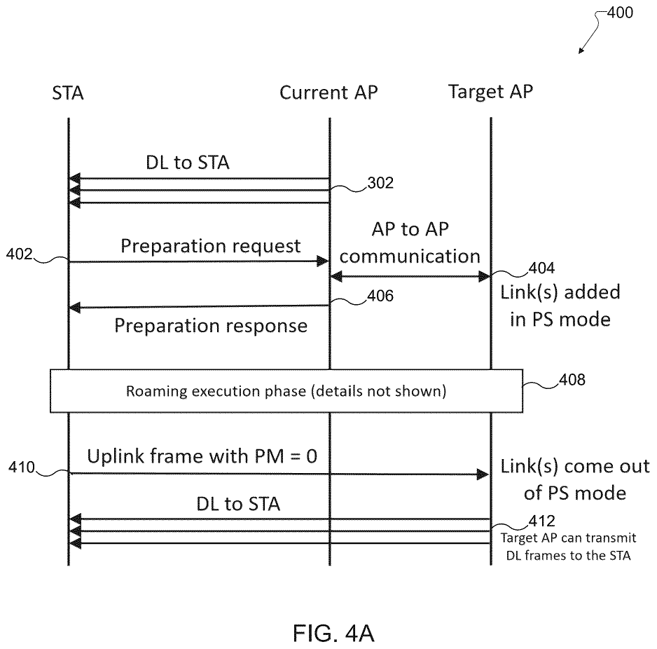

FIG. 5 illustrates an example of a power save indication in A-control field 500 according to embodiments of the present disclosure. The embodiment of the example power save indication in A-control field 500 shown in FIG. 5 is for illustration only. Other embodiments could be used without departing from the scope of this disclosure.

According to one embodiment, the power save indication can be provided in an A-control field. The A-control field can have the format as shown in FIG. 5.

According to another embodiment, the above information can also be carried in the feedback in the per AID TID info subfield of a Multi-STA BA frame. A value of 1 in the ith position of the link indication bitmap can indicate to the AP MLD, that the non-AP MLD is making an indication for the link with link ID equal to i. The start time can indicate the start time of the start or stop action.

The above signaling can be coupled with the PM bit which can take a value as per the specification to indicate entering or exiting the power save mode. When the PM bit is set to a value indicating the start of power save mode, the above information can indicate a stop message for the indicated links starting at a time indicated by the start time indication. When the PM bit is set to a value indication the stop of a power save mode, the above information can indicate the start message for the indicated links starting at a time indicated by the start time indication.

Various embodiments provide for dynamic unavailability indication. According to one embodiment, the non-AP MLD can provide a DUO indication to the current AP MLD to indicate its unavailability. The start time of the unavailability can be the time at which the current AP MLD can stop to transmit downlink frames to the non-AP MLD. The duration of unavailability can be set to a reserved/predetermined value.

Various embodiments provide for a null frame based start indication. According to one embodiment, a non-AP MLD that has transitioned to the target AP MLD can transmit a null frame to the target AP MLD. Upon receiving the null frame, the target AP MLD can understand that the non-AP MLD has transitioned to its links and can start to transmit frames to the non-AP MLD.

Various embodiments provide for uplink frame based start indication. According to one embodiment, the non-AP MLD that has transitioned to the target AP MLD can transmit an uplink frame to the target AP MLD. Upon receiving the uplink frame, the target AP MLD can understand that the non-AP MLD has transitioned to its links and can start to transmit frames to the non-AP MLD.

Various embodiments provide for a link delete/timeout based indication. According to one embodiment, when there is a timeout at the current AP MLD after roam execution phase completion, the current AP MLD can inform the target AP MLD about the timeout, and the target AP MLD can start to transmit downlink frames to the non-AP MLD. If the target AP MLD does not receive any response (e.g., acknowledgements) to its transmitted frames until another timeout period, then it can assume that the non-AP MLD cannot transition to it and can disassociate the non-AP MLD.

According to one embodiment, when the non-AP MLD has deleted its links at the current AP MLD after roam execution phase completion, the current AP MLD can inform the target AP MLD about the link deletion, and the target AP MLD can start to transmit downlink frames to the non-AP MLD. If the target AP MLD does not receive any response (e.g., acknowledgements) to the target AP MLD's transmitted frames until another timeout period, then the target AP MLD can assume that the non-AP MLD cannot transition to the target AP MLD and can disassociate the non-AP MLD.

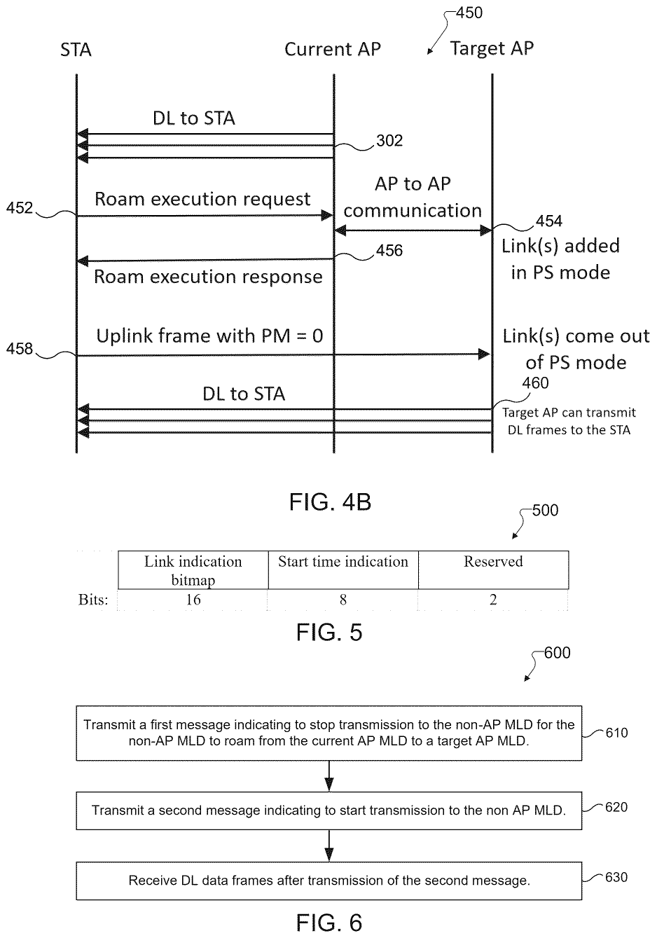

FIG. 6 illustrates an example method 600 performed by an AP MLD in a wireless communication system according to embodiments of the present disclosure. The method 600 of FIG. 6 can be performed by any of the APs 101-103 of FIG. 1, such as the AP MLD 101 of FIG. 2A, and a corresponding method can be performed by any of the STAs 111-114 of FIG. 1, such as non-AP MLD 111 of FIG. 2B. The method 600 is for illustration only and other embodiments can be used without departing from the scope of the present disclosure.

The method 600 begins with the non-AP MLD transmitting, to a current AP MLD, a first message indicating to stop transmission to the non-AP MLD for the non-AP MLD to roam from the current AP MLD to a target AP MLD (610). The non-AP MLD transmits, to the target AP MLD, a second message indicating to start transmission to the non-AP MLD (620). In various embodiments, the non-AP MLD sets up one or more links with the target AP MLD in a power save mode for the roam to the target AP MLD and transitions the one or more links out of the power save mode after transmitting the second message. In various embodiments, the first message is transmitted during a DL draining period with the current AP MLD for the roam to the target AP MLD and indicates early termination of the DL draining period. The second message further indicates that the DL draining period was terminated early.

The non-AP MLD receives, from the target AP MLD, DL data frames after transmission of the second message (630). In various embodiments, the second message is transmitted on a first link between the non-AP MLD and the target AP MLD and indicates to start transmitting frames to the non-AP MLD on the first link. The DL data frames are received on the first link. In various embodiments, the second message is transmitted on a first link between the non-AP MLD and the target AP MLD and indicates to start transmitting frames to the non-AP MLD on all links between the non-AP MLD and the target AP MLD. The DL data frames are received on a second link between the non-AP MLD and the target AP MLD.

In various embodiments, SNs associated with the DL data frames received from the target AP MLD are reset relative to SNs associated with DL data frames previously received from the current AP MLD. In various embodiments, the non-AP MLD transmits, to the current AP MLD, a ST preparation request indicating to transfer SNs for the DL data frames for TIDs. The DL data frames received from the target AP MLD are associated with next SNs relative to DL data frames previously received from the current AP MLD.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a non-access point (AP) multi-link device (MLD), the method comprising:
transmitting, to a current AP MLD, a first message indicating to stop transmission to the non-AP MLD for the non-AP MLD to roam from the current AP MLD to a target AP MLD;
transmitting, to the target AP MLD, a second message indicating to start transmission to the non-AP MLD; and
receiving, from the target AP MLD, downlink (DL) data frames after transmission of the second message.

2. The method of claim 1, wherein:
the second message is transmitted on a first link between the non-AP MLD and the target AP MLD and indicates to start transmitting frames to the non-AP MLD on the first link, and
the DL data frames are received on the first link.

3. The method of claim 1, wherein:
the second message is transmitted on a first link between the non-AP MLD and the target AP MLD and indicates to start transmitting frames to the non-AP MLD on all links between the non-AP MLD and the target AP MLD, and
the DL data frames are received on a second link between the non-AP MLD and the target AP MLD.

4. The method of claim 1, further comprising:
setting up one or more links with the target AP MLD in a power save mode for the roam to the target AP MLD, and
transitioning the one or more links out of the power save mode after transmitting the second message.

5. The method of claim 1, wherein:
the first message is transmitted during a downlink (DL) draining period with the current AP MLD for the roam to the target AP MLD and indicates early termination of the DL draining period, and
the second message further indicates that the DL draining period was terminated early.

6. The method of claim 1, wherein sequence numbers (SNs) associated with the DL data frames received from the target AP MLD are reset relative to SNs associated with DL data frames previously received from the current AP MLD.

7. The method of claim 1, further comprising:
transmitting, to the current AP MLD, a state transition (ST) preparation request indicating to transfer sequence numbers (SNs) for the DL data frames for traffic identifiers (TIDs),
wherein the DL data frames received from the target AP MLD are associated with next SNs relative to DL data frames previously received from the current AP MLD.

8. A method performed by a target access point (AP) multi-link device (MLD), the method comprising:
receiving, from the non-AP MLD, a second message indicating to start transmission to the non-AP MLD, wherein a first message indicates to stop transmission to the non-AP MLD for the non-AP MLD to roam from a current AP MLD to the target AP MLD; and
transmitting, to the non-AP MLD, downlink (DL) data frames after receipt of the second message.

9. The method of claim 8, wherein:
the second message is transmitted on a first link between the non-AP MLD and the target AP MLD and indicates to start transmitting frames to the non-AP MLD on the first link, and
the DL data frames are received on the first link.

10. The method of claim 8, wherein:
the second message is received on a first link between the non-AP MLD and the target AP MLD and indicates to start transmitting frames to the non-AP MLD on all links between the non-AP MLD and the target AP MLD, and
the DL data frames are received on a second link between the non-AP MLD and the target AP MLD.

11. The method of claim 8, further comprising:
setting up one or more links with the non-AP MLD in a power save mode for the roam to the target AP MLD, and
transitioning the one or more links out of the power save mode after receiving the second message.

12. The method of claim 8, wherein the second message further indicates that a downlink (DL) draining period with the current AP MLD was terminated early by the first message.

13. The method of claim 8, wherein sequence numbers (SNs) associated with the DL data frames transmitted to the non-AP MLD are reset relative to SNs associated with DL data frames from the current AP MLD.

14. The method of claim 8, further comprising determining to use next sequence numbers (SNs) for the DL data frames transmitted to the non-AP MLD, relative to prior DL data frames from the current AP MLD, based receipt of an indication to transfer sequence numbers (SNs) for the DL data frames for traffic identifiers (TIDs).

15. A non-access point (AP) multi-link device (MLD), comprising:
at least one processor including processing circuitry; and
memory storing instructions, wherein the instructions, when executed by the at least one processor individually or collectively, cause the non-AP MLD:
transmit, to a current AP MLD, a first message indicating to stop transmission to the non-AP MLD for the non-AP MLD to roam from the current AP MLD to a target AP MLD;
transmit, to the target AP MLD, a second message indicating to start transmission to the non-AP MLD; and
receive, from the target AP MLD, downlink (DL) data frames after transmission of the second message.

16. The non-AP MLD of claim 15, wherein:
the second message is transmitted on a first link between the non-AP MLD and the target AP MLD and indicates to start transmitting frames to the non-AP MLD on the first link, and
the DL data frames are received on the first link.

17. The non-AP MLD of claim 15, wherein:
the second message is transmitted on a first link between the non-AP MLD and the target AP MLD and indicates to start transmitting frames to the non-AP MLD on all links between the non-AP MLD and the target AP MLD, and
the DL data frames are received on a second link between the non-AP MLD and the target AP MLD.

18. The non-AP MLD of claim 15, wherein the instructions, when executed by the at least one processor individually or collectively, cause the non-AP MLD to:
set up one or more links with the target AP MLD in a power save mode for the roam to the target AP MLD, and
transition the one or more links out of the power save mode after transmitting the second message.

19. The non-AP MLD of claim 15, wherein:
the first message is transmitted during a downlink (DL) draining period with the current AP MLD for the roam to the target AP MLD and indicates early termination of the DL draining period, and
the second message further indicates that the DL draining period was terminated early.

20. The non-AP MLD of claim 15, wherein sequence numbers (SNs) associated with the DL data frames received from the target AP MLD are reset relative to SNs associated with DL data frames previously received from the current AP MLD.
